(19) United States
(12) Patent Application Publication
(10) Pub. No.: US 2003/0128159 A1
(43) Pub. Date: Jul. 10, 2003

(54) 1-D electronic scanned satellite user terminal antenna

(76) Inventors: Michael de La Chapelle, Bellevue, WA (US); George S. LaRue, Pullman, WA (US)

Correspondence Address: HARNESS, DICKEY & PIERCE, P.L.C., P.O. BOX 828, BLOOMFIELD HILLS, MI, 48303, US

(21) Appl. No.: 10/043,650

(22) Filed: Jan. 10, 2002

(51) Int. Cl. H01Q 3/00

(52) U.S. Cl. 342/359; 342/372; 343/757

(57) ABSTRACT

A fixed terrestrial user terminal antenna for use with a satellite communication systems in which satellites orbit earth in a constellation comprised of a plurality of spaced orbital planes with each orbital plane of the plurality of orbital planes having a plurality of satellites. The user terminal antenna comprising a base with a tilt plate connected to the base. The tilt plate having a one-dimensional electronically scanned phased array antenna that scans along a single axis is attached to the tilt plate so that the array antenna tilts with the tilting of the tilt plate. The array antenna tracks individual satellites of the plurality of satellites in an orbital plane of the plurality of orbital planes as the individual satellites travel through a field of view of the array antenna.

### FIELD OF THE INVENTION

The present invention relates to user terminal antennas for satellite communication systems and, more particularly, to user terminal antennas for satellite communication systems in which satellites orbit earth in a constellation comprised of a plurality of spaced orbital planes with each orbital plane of the plurality of orbital planes having a plurality of satellites.

### BACKGROUND OF THE INVENTION

Satellite communication systems in which satellites orbit the earth in a constellation comprised of a plurality of spaced orbital planes with each orbital plane of the plurality of orbital planes having a plurality of satellites employ a user terminal antenna (“UTA”) to communicate with the satellite communication system. The UTA is fixed to the earth at a location that provides a view of the sky for the UTA. The UTA has a field of view within which the UTA can communicate with any satellite of the satellite communication system that is within the field of view.

The rotation of the earth causes each orbital plane of the plurality of orbital planes to ascend into, pass through, and descend out of the east-west field of view of the UTA as the earth rotates. That is, the particular orbital plane of the plurality of orbital planes that is within the field of view of the UTA will change as the earth rotates. Typical satellite communication systems employ a sufficient number of orbital planes so that as one orbital plane is descending out of the field of view of the UTA, another orbital plane is ascending into the field of view of the UTA so that an orbital plane is within the field of view of the UTA at all times. Additionally, due to the orbiting about the earth of the plurality of satellites in each orbital plane, when an orbital plane of the plurality of orbital planes is within the field of view of the UTA, the plurality of satellites in that orbital plane will ascend into, pass through, and descend out of the field of view of the UTA as the plurality of satellites travel in that orbital plane. That is, the particular satellites of the plurality of satellites in that orbital plane that are within the field of view of the UTA will change as the plurality of satellites orbit in that orbital plane. Typical satellite communication systems employ a sufficient number of satellites in each orbital plane so that at least one satellite of the plurality of satellites in an orbital plane will always be within the field of view of the UTA so that uninterrupted communication can occur. The ascending into, passing through, and descending out of the field of the view of the UTA by the plurality of satellites will continue for as long as that orbital plane is within the field of view of the UTA. When that orbital plane passes out of the field of view of the UTA, a different orbital plane of the plurality of orbital planes will be within the field of view of the UTA and individual satellites of the plurality of satellites in the different orbital plane will be passing through the field of view of the UTA so that at least one satellite of the satellite communication system is always in the field of view of the UTA.

Due to the orbiting of the plurality of satellites in an orbital plane and the rotation of the earth, the UTA must be capable of: 1) acquiring and tracking an individual satellite as the individual satellite passes through the field of view of the UTA; 2) acquiring and tracking a different individual satellite in the same orbital plane after a previously acquired and tracked individual satellite has left the field of view of the UTA; 3) tracking an orbital plane as it passes through the field of view of the UTA; and 4) tracking a different individual orbital plane of the plurality of orbital planes after a previously tracked individual orbital plane has left the field of view of the UTA. Therefore, the UTA must be capable of tracking the sky track of the plurality of satellites within a particular orbital plane along with tracking the movement of the plurality of orbital planes due to the rotation of the earth when in the field of view of the UTA.

The typical prior art UTA for communication with such a satellite communication system uses a dual dish configuration. In a dual dish configuration, a first dish is tracking and communicating with a satellite in the field of view of the UTA while a second dish is acquiring or preparing to acquire a different satellite that is entering the field of view. In this manner, the communication function can be transferred from the first dish to the second dish without any interruption in the communication. The transfer of communications from one satellite to another is referred to as handoff. The dual dish design can provide uninterrupted communication for both intra-plane and inter-plane satellite hand offs.

These dual dish prior art UTAs are not without drawbacks. Dual dish UTAs are relatively large in size. The large size of the dual dish UTA makes it difficult to handle and install. The large size is also esthetically unpleasing. Additionally, some local codes may prevent the installation of the dual dish UTA in desirable locations, such as on roof tops or other locations that provide unobstructed views to the sky.

A prior art alternative to the dual dish UTA uses a two dimensional electronically scanned phased array antenna instead of dual dishes. The two dimensional electronically scanned phased array antennas are essentially flat and the overall assembly has a size that is significantly smaller than that of the dual dish UTA. However, the two dimensional electronically scanned phased array antennas are very expensive compared to the dual dish UTAs. The high cost of the two dimensional electronically scanned phased array antennas limits the number of potential users who can afford to purchase such a UTA and utilize the satellite communication system. The limiting of the number of potential users of the satellite communication systems changes the economic justification of developing and deploying such a system and may make the system economically unfeasible.

Therefore, what is needed is a UTA that is of a compact size so that the UTA is easy to install, esthetically pleasing, and does not run a afoul of typical local codes that govern the placement of a UTA in desirable locations. Furthermore, the cost of the UTA should be affordable to a large number of potential users so that the satellite communication system in which the UTA is to be used is economically feasible.

### SUMMARY OF THE INVENTION

The present invention is directed to a UTA which overcomes the disadvantages associated with the prior art UTAs for use with a satellite communication system in which satellites orbit earth in a constellation comprised of a plurality of spaced orbital planes with each orbital plane of the plurality of orbital planes having a plurality of satellites. The present invention is also directed to a method of using such a UTA.

The UTA of the present invention has a base that provides support for the UTA. A tilt plate is connected to the base. The tilt plate is capable of being tilted relative to the base. A one dimensional electronically scanned phased array antenna (hereinafter “array antenna”) that scans along a single scan axis is attached to the tilt plate. The array antenna tilts with the tilting of the tilt plate. The array antenna tracks individual satellites of the plurality of satellites in an orbital plane of the plurality of orbital planes as the individual satellites travel through a field of view of the array antenna so that the array antenna can transmit data to and receive data from the individual satellites.

Preferably, the scan axis of the array antenna is oriented to be generally aligned with the orbits of the plurality of satellites in the plurality of orbital planes so that the array antenna can track a first satellite of the plurality of satellites in a first orbital plane of the plurality of orbital planes as the first satellite in the first orbital plane travels through the field of view of array antenna. Even more preferably, the tilt plate tilts about a single tilt axis that is generally aligned with the scan axis, and the tilt plate tilts about the tilt axis as the array antenna tracks the first satellite in the first orbital plane. The tilting of the tilt plate compensates for the rotation of the earth so that the field of view of the array antenna remains oriented toward the first orbital plane and the array antenna is capable of transmitting data to and receiving data from the first satellite in the first orbital plane.

When the first satellite in the first orbital plane being tracked by the array antenna reaches a predetermined satellite release location in the field of view of the array antenna, the array antenna switches from tracking the first satellite in the first orbital plane to tracking a second satellite of the plurality of satellites in the first orbital plane. When the second satellite in the first orbital plane reaches the predetermined satellite release location in the field of view of the array antenna, the array antenna switches from tracking the second satellite in the first orbital plane to tracking a third satellite of the plurality of satellites in the first orbital plane. This procedure continues for each satellite of the plurality of satellites in the first orbital plane until the first orbital plane reaches a predetermined orbital plane release location.

When the first orbital plane reaches the predetermined orbital plane release location, the array antenna switches from tracking individual satellites of the plurality of satellites in the first orbital plane to tracking individual satellites of the plurality of satellites in a second orbital plane of the plurality of orbital planes. To accomplish the switching of the array antenna from tracking individual satellites in the first orbital plane to tracking individual satellites in the second orbital plane, the tilt plate tilts about the tilt axis to a predetermined orbital plane acquisition location. The switching of orbital planes is accomplished by a retrace of the tilt plate. The tilting of the tilt plate to the predetermined orbital plane acquisition location causes the field of view of the array antenna to be oriented toward the second orbital plane of the plurality of orbital planes so that a first individual satellite of the plurality of satellites in the second orbital plane of the plurality of orbital planes can be tracked and data transmitted to and received from the first individual satellite in the second orbital plane. The array antenna then proceeds to track each satellite of the plurality of satellites in a second orbital plane until the second orbital plane reaches the predetermined orbital plane release location at which time the tilt plates tilts about the tilts axis to the predetermined orbital plane acquisition location. The tilting of the tilt plate to the predetermined orbital plane acquisition location causes the field of view of the array antenna to be oriented toward a third orbital plane of the plurality of orbital planes so that a first individual satellite of the plurality of satellites in the third orbital plane of the plurality of orbital planes can be tracked and data transmitted to and received from the first individual satellite in the third orbital plane. This procedure is continued for each orbital plane of the plurality of orbital planes, and then repeated ad infinitum.

The use of a one dimensional electronically scanned phased array antenna that has a single tilt axis provides a compact UTA. Additionally, the cost of a one dimensional electronically scanned phased array antenna is significantly less than the cost of a two-dimensional electronically scanned phased array antenna. Therefore, the present invention overcomes the disadvantages of prior art UTAs by providing an inexpensive, compact and simple UTA that can be used with the satellite communication system described above.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1A is a side elevation view of the UTA of the present invention showing the tilt plate and array antenna;

FIG. 1B is a front elevation view of the UTA of FIG. 1A showing the apertures of the array antenna;

FIG. 2 is a polar view of a satellite constellation compatible with the invention having a plurality of orbital planes in polar orbits;

FIG. 3 is a graphical representation of the electronically scanned axis and the mechanical tilt axis of the UTA of FIGS. 1A-B used with the satellite constellation of FIG. 2;

FIG. 4A is a graphical representation of the ground tracks made by a plurality of satellites within an orbital plane of the satellite constellation of FIG. 2 as the earth rotates and with the plurality of satellites descending to the North from the perspective of a user on the ground;

FIG. 4B is a graphical representation of the ground tracks made by a plurality of satellites within an orbital plane of the satellite constellation of FIG. 2 as the earth rotates and with the plurality of satellites descending to the South from the perspective of a user on the ground;

FIG. 5 is a graphical representation of the array antenna switching from tracking a first satellite in an orbital plane to tracking a second satellite within the same orbital plane of the satellite constellation of FIG. 2;

FIG. 6 is a simplified graphical representation viewed from a point above the south pole showing the track of an individual satellite within an orbital plane of the satellite constellation of FIG. 2 as the satellite rises and sets from the perspective of a UTA on the equator; and

FIG. 7 a simplified graphical representation of the phenomena shown in FIG. 6 viewed from a point above the equator.

### DETAILED DESCRIPTION OF THE PREFERRED EMBODIMENTS

The following description of the preferred embodiment(s) is merely exemplary in nature and is in no way intended to limit the invention, its application, or uses.

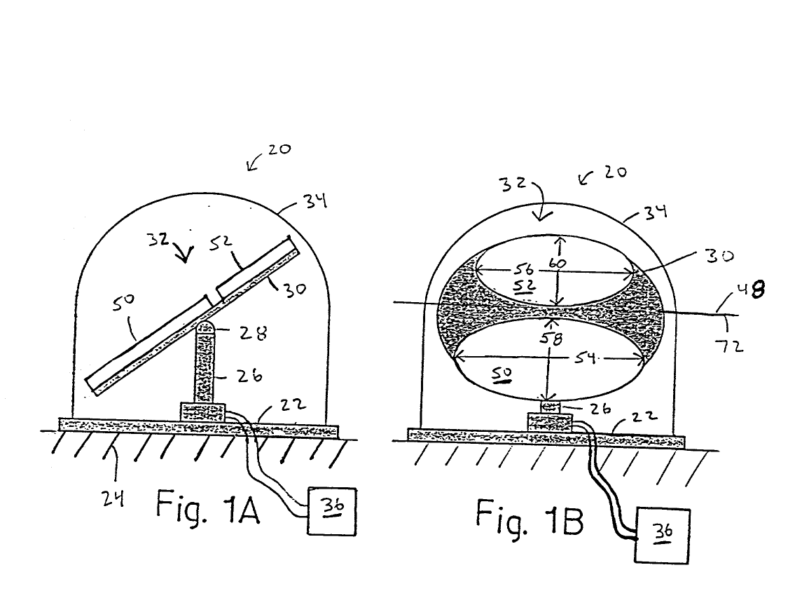

Referring to FIGS. 1A-B, there is shown a user terminal antenna (UTA) 20 in accordance with a preferred embodiment of the present invention. The UTA has a base 22 which is attached to a fixture 24, such as a roof top. The base 22 has a pedestal 26 that extends upwardly from the base 22. A gimbal 28 is attached to the pedestal 26. A tilt plate 30 is attached to the gimbal 28. A one dimensional electronically scanned phased array antenna (array antenna) 32 is attached to the tilt plate 30. A radome 34 is attached to the base 22 and covers the UTA 20 so that the UTA 20 is protected from the environment. The UTA 20 is connected to a controller 36. The controller 36 controls the operation of the UTA 20.

The UTA 20 is designed for use with a satellite communication system 38 in which satellites 40 orbit the earth 41 in a constellation. The constellation is comprised of a plurality of spaced orbital planes 44. Preferably, the orbital planes 44 are highly inclined orbital planes. Highly inclined orbital planes have an inclination approximately between 700 and 1100 with respect to the equatorial plane of the earth.

Each orbital plane 44 has a plurality of satellites 40 that orbit the earth 41 in the orbital plane 44. Preferably, the orbital planes 44 are spaced apart so that the orbital planes 44 can provide satellite coverage to the entire earth 41. Even more preferably, the orbital planes 44 are equally spaced apart.

For the purpose of explaining the present invention and method, the orbits of the satellites 40 in the orbital planes 44 will be discussed as being and shown in the Figures as being true polar orbits. However, it should be understood that the invention and method disclosed are equally applicable to satellites 40 that orbit the earth 41 in orbital planes 44 that are not polar or near polar orbits. Therefore, the present invention and method are not limited to satellite communication systems 38 in which satellites 40 orbit the earth 41 in orbital planes 44 that are polar orbits and that satellites 40 that orbit the earth 41 in orbital planes 44 that are non-polar orbits are within the scope of the invention as defined by the claims.

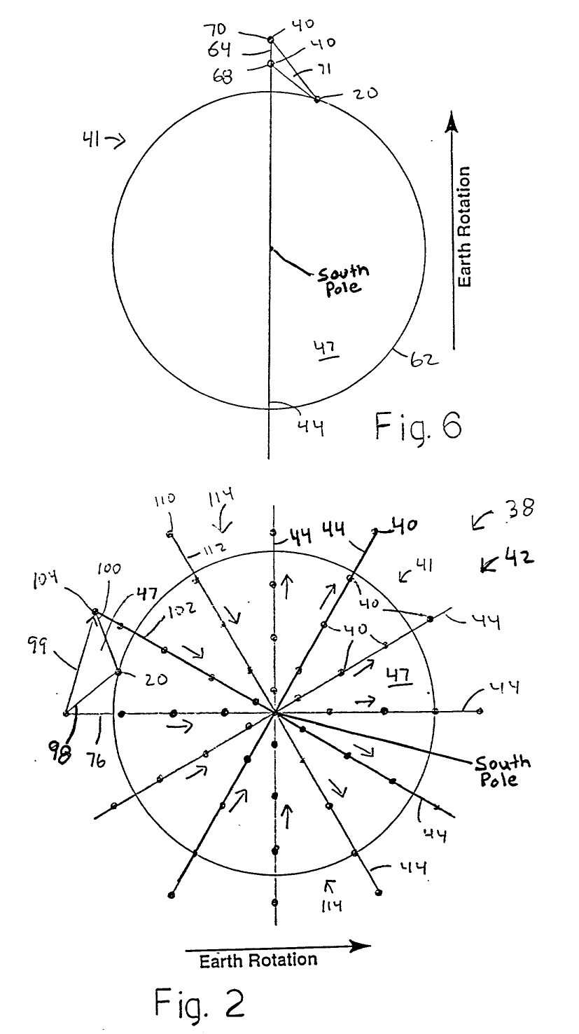

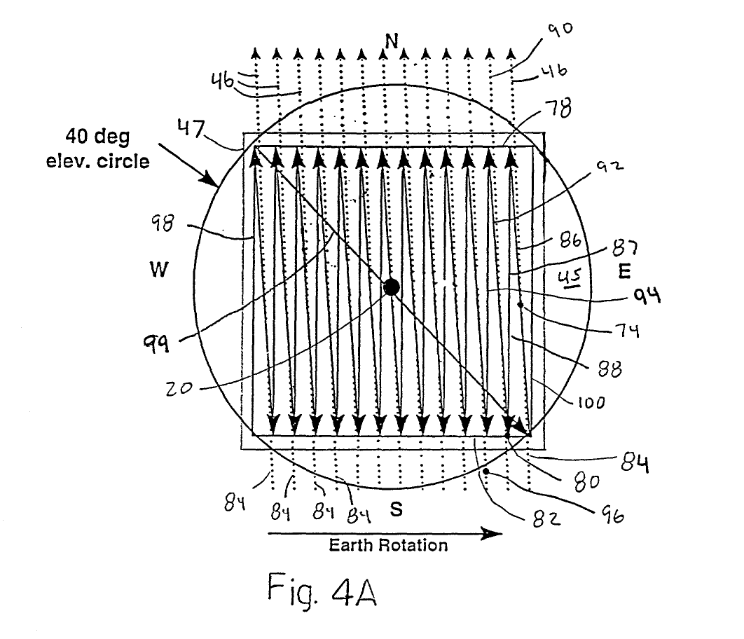

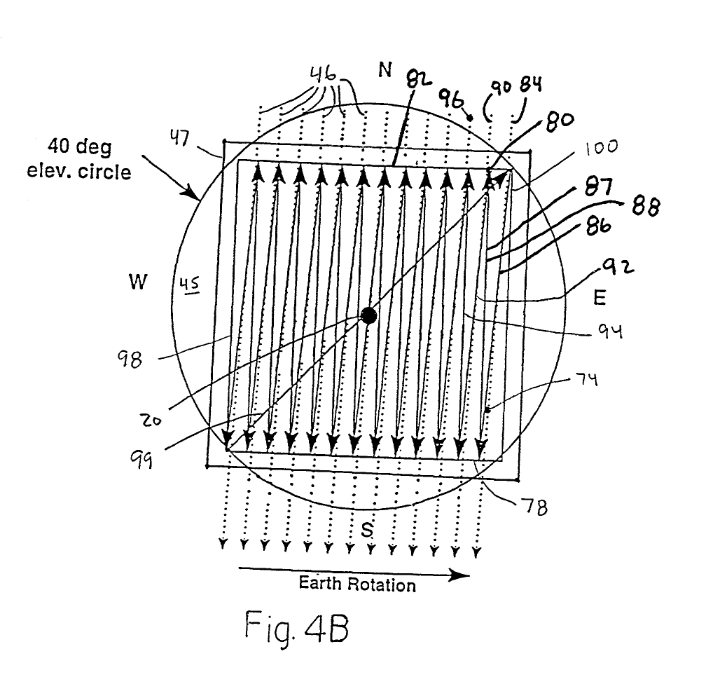

Preferably, the orbits of the satellites 40 in the orbital planes 44 are polar or near polar orbits, as shown in FIG. 2. As can be seen in FIGS. 4A-B, when the satellites 40 orbit above the surface 45 of the earth 41 in a polar orbital plane 44 each satellite 40 projects a ground track 46 on the earth's surface 45. FIG. 4A shows the ground tracks 46 projected on the earth's surface 45 within a field of view 47 of the UTA 20, at arbitrarily selected 400 of elevation. In FIG. 4A, the satellites 40 are ascending in a polar orbit from the South and descending to the North. FIG. 4B shows the same satellites 40 making ground tracks 46 on an opposite side of the earth 41 within the field of view 47 of the UTA 20 at 400 of elevation when the satellites 40 are ascending from the North and descending to the South in a polar orbit. If the earth 41 did not rotate, the ground tracks 46 of each satellite 40 within the same orbital plane 44 would all be aligned and overlap and the ground tracks 46 would be a single ground track 46 that would extend North and South in the case of a polar orbit. However, because the earth 41 does rotate, the ground tracks 46, as can be seen in FIGS. 4A-B, have a slant to the West as the satellite 40 orbits above the earth's surface 45. The Western slant of the ground tracks 46 is caused by the rotation of the earth 41. The rotation of the earth 41 will cause an individual orbital plane 44 to pass along the earth's surface 45 from the East to the West. As a result, each satellite 40 within the orbital plane 44 will project a different ground track 46 over the earth's surface 45 as the earth 41 rotates. For example, as can be seen in FIGS. 4A-B, thirteen different ground tracks 46 are projected on the earth's surface 45 by the plurality of satellites 40 orbiting in the orbital plane 44. It should be understood that the showing of thirteen different ground tracks 46 was for example only and that the actual number of ground tracks 46 will vary depending on the details of the satellite communication system 38 and the capabilities of the UTA 20.

The ground tracks 46 projected by the satellites 40 orbiting the earth 41 in the orbital plane 44 as seen in FIGS. 4A-B will be repeated across the earth's surface 45 for each orbital plane 44 that has a plurality of satellites 40. As can be seen in FIG. 2, as the earth 41 rotates, the particular orbital plane 44 that passes over the earth's surface 45 where the UTA 20 is located will vary. That is, different orbital planes 44 will pass through the field of view 47 of the UTA 20 as the earth 41 rotates.

The array antenna 32 is capable of scanning along a single scan axis 48. Preferably, the scan axis 48 of the array antenna 32 is aligned with the orbits of the plurality of satellites 40 in the plurality of orbital planes 44. That is, when the satellites 40 orbit the earth 41 in orbital planes 44 that are polar, the scan axis is preferably oriented in the North-South direction. The orienting of the scan axis 48 of the array antenna 32 to be aligned with the orbits of the plurality of satellites 40 in the plurality of orbital planes 44 allows the array antenna 32 to track the plurality of satellites 40 in orbital plane 44 as the satellites 40 orbit about the earth 41 in the field of view 47 of the UTA 20, as will be discussed in more detail below. The array antenna 32 is capable of transmitting data to and receiving data from any satellite 40 which is being tracked by the array antenna 32.

Preferably, the array antenna 32 is a dual aperture array antenna 32 so that the array antenna 32 can simultaneously transmit data to and receive data from the satellite 40 that is being tracked by the array antenna 32. Preferably, the array antenna 32 has separate transmission and reception apertures 50, 52. However, it should be understood that a single combination transmission and reception aperture could be utilized and still be within the scope of the invention as defined by the claims. The transmission aperture 50 is used to transmit data to a satellite 40 that is being tracked by the array antenna 32. The reception aperture 52 is used to receive data being transmitted from the satellite 40 that is being tracked by the array antenna 32. The transmission and reception apertures 50, 52 have respective lengths 54, 56 and respective widths 58, 60. Preferably, the lengths 54, 56 of the respective transmission and reception apertures 50, 52 are greater than the respective widths 58, 60 of the transmission and reception apertures 50, 52. Preferably, the lengths 54, 56 of the respective transmission and reception apertures 50, 52 extend along the scan axis 48 and the widths 58, 60 of the respective transmission or reception apertures 50, 52 are generally perpendicular to the respective lengths 54, 56. However, it should be understood that the lengths 54, 56 of the respective transmission and reception apertures 50, 52 do not need to extend along the scan axis 48 and that the widths 58,60 do not need to be perpendicular to the respective lengths 56, 56 to be within the scope of the invention as defined by the claims.

As is known in the art, the narrower the aperture in a given direction the wider the antenna beam projected by the aperture in said given direction. Therefore, when an orbit being tracked by an aperture can be tracked very precisely along an axis, the aperture can be wider along that axis and the beam can be narrower and, conversely, when the orbit being tracked by an aperture cannot be precisely tracked along an axis the aperture must be narrower along that axis in order to produce a wider beam that will encompass the orbit being tracked. The electronic scanning of the array antenna 32 along the scan axis 48 is very precise, accomplished with either closed or open loop tracking. Therefore, a narrow beam will be able to encompass the satellite 40 along the electronically scanned axis corresponding to the long dimension of the antenna apertures 50, 52.

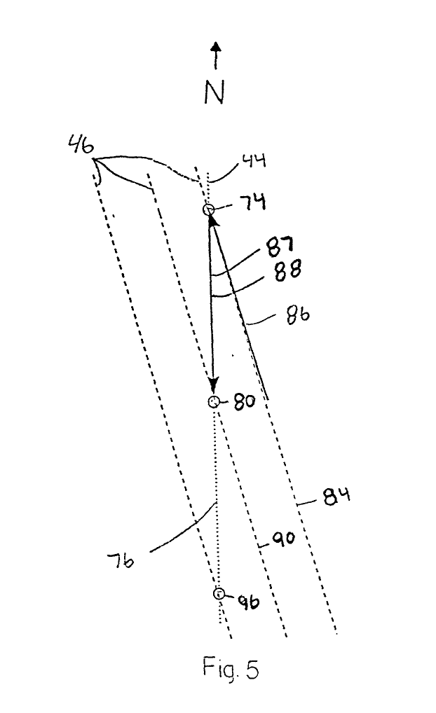

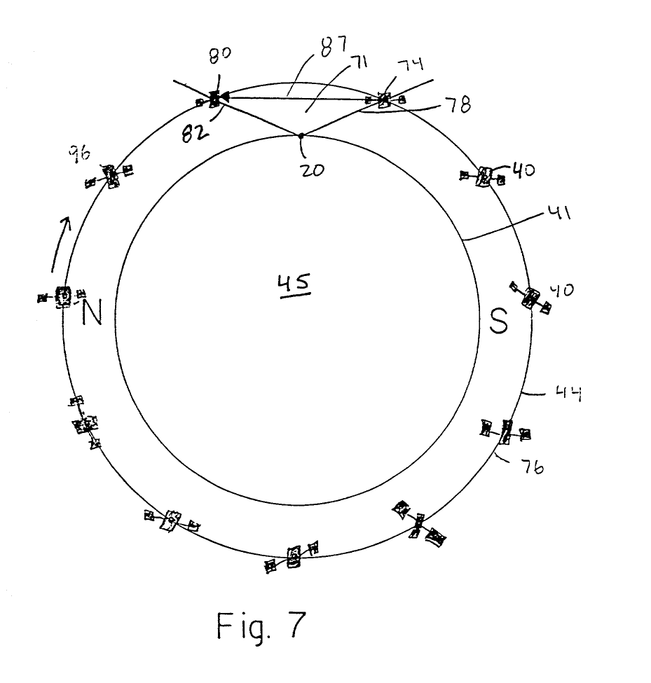

Now referring to FIG. 6, a simplistic view of a single satellite 40 orbiting about the earth 41 in a single orbital plane 44 is shown from a perspective of looking down on the earth 41 from above the South pole. When the UTA 20 is positioned on the equator 62 of the earth 41 so that the UTA 20 is not aligned with the orbital plane 44, the individual satellite 40 will have a sky track 64 that is curved. That is, when the individual satellite 40 is in a rising or setting position indicated as 68, the individual satellite 40 appears low on the horizon. As the individual satellite 40 orbits the earth 41 in the orbital plane 44 and approaches a location where the individual satellite 40 is directly West, indicated as 70, (or directly East, which is not shown) of the UTA 20 the individual satellite 40 will appear highest on the horizon. Similarly, the satellites will appear lowest on the horizon when they rise and set at position 68. This is true for each satellite 40 that orbits in orbital plane 44 when the user terminal 20 is not directly below the sky track 64 of the satellite 40 in the orbital plane 44. The curvature of the sky track 64 can be accommodated by using a widened beam in the East-West direction or by mechanically tracking the satellite position change in the East-West direction. The beam widths of the transmission and reception apertures 50, 52 need to be wide enough to account for the changes in the elevation of the satellites 40 as the satellites 40 orbit from the rising position 68 to the directly West position 70 (or directly East position, which is not shown) and to the setting position 68. When the orbits are polar orbits, it is preferred that the widths 58, 60 of the respective transmission and reception apertures 52, 54 be generally aligned with the East-West direction. Therefore, the widths 58, 60 of the respective transmission and reception apertures 50, 52 are designed to produce wide beams that encompass the elevation changes of the individual satellites 40 as the satellites 40 orbit the earth 41. Because the array antenna 32 does not electronically scan along the East-West directions, the widths 58, 60 of the respective transmission and reception apertures 50, 52 are preferably narrower than the lengths 54, 56 of the respective transmission and reception apertures 50, 52. The width of the beams projected by the respective transmission and reception apertures 50, 52 define a field of view 71 of the array antenna 32. That is, the field of view 71 of the array antenna 32 represents a volume of space within which the array antenna 32 is capable of transmitting data to and receiving data from any satellite 40 within the field of view 71 of the array antenna 32.

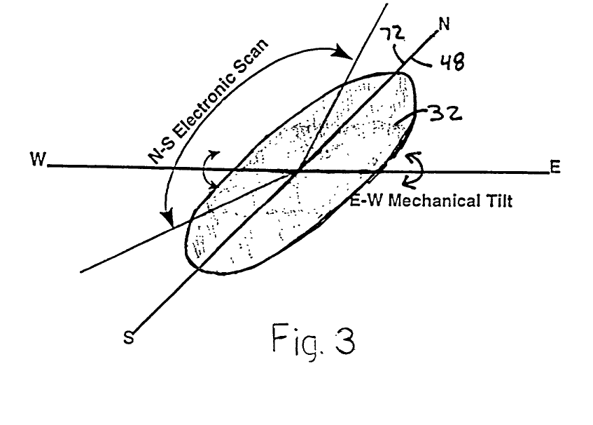

The gimbal 28 allows the tilt plate 30 to tilt relative to the base 22. The gimbal 28 allows the tilt plate 30 to tilt about a single tilt axis 72. Preferably, the tilt axis 72 is aligned with the electronic scan direction 48 of the array antenna 32. The aligning of the tilt axis 72 with the scan direction 48 allows the array antenna 32 to tilt perpendicularly to the scan direction 48. The tilting of the array antenna 32 about the tilt axis 72 keeps the field of view 71 of the array antenna 32 oriented towards an orbital plane 44 as the earth 41 rotates and allows the array antenna 32 to track individual satellites 40 in an orbital plane 44 as the orbital plane 44 travels from East of the UTA 20 to directly overhead of the UTA 20 to West of the UTA 20, as will be discussed in more detail below. As can be seen in FIG. 3, when the tilt axis 72 is aligned with the scan axis 48 of the array antenna 32 and the scan axis 48 extends in a North and South direction, the array antenna 32 is capable of electronically scanning along the North-South direction and of tilting along the East-West direction.

The field of view 47 of the UTA 20 is defined by the field of view 71 of the array antenna 32 along with the range through which the tilt plate 30 can be tilted about the tilt axis 72. That is, the field of view 47 of the UTA 20 is a projection of the field of view 71 of the array antenna 32 swept through the full range through which the tilt plate 30 can be tilted about the tilt axis 72. The field of view 47 of the UTA 20, therefore, represents the volume that a satellite 40 can be within and be able to communicate with the UTA 20.

The controller 36 connected to the UTA 20 controls the electronic scanning of the array antenna 32 along with the tilting of the array antenna 32 about the tilt axis 72. The controller 36 knows the orbital information of the constellation of the satellite communication system 38 so that the controller 36 can control the operation of the UTA 20 and maintain contact with the satellite communication system 38. The tilting of the array antenna 32 about the tilt axis 72 changes the orientation of the array antenna 32 and the orientation of the associated field of view 71 of the array antenna 32. That is, the field of view 71 of the array antenna 32 can be oriented toward any particular point in the sky by tilting the array antenna 32 about the tilt axis 72 and electronically scanning along the scan axis 48. Therefore, the UTA 20 can track individual satellites 40 in the orbital planes 44 that pass within the range of movement of the UTA 20 and within the field of view 47 of the UTA 20.

While the tilt axis 72 has been described and shown as being generally aligned with the scan axis 48, it should be understood that this is for the case of polar orbits by the satellites 40. The tilt axis 72 is oriented so that the tilt plate 30 can tilt about the tilt axis 72 to compensate for the rotation of the earth 41. When the orbits are not polar orbits, the tilt axis 72 is likely to not be generally aligned with the scan axis 48 so that the tilt plate 30 can compensate for the rotation of the earth 41 while the scan axis 48 is generally aligned with an orbital plane 44. Therefore, it should be understood that the tilt axis 72 does not need to be aligned with the scan axis 48 to be within the scope of the invention as defined by the claims.

The above described field of view 47 of the UTA 20, represents a maximum field of view of the UTA 20 within which the UTA 20 can communicate with any satellite 40. However, obstructions can prevent the UTA 20 from communicating with a satellite 40 in all parts of the maximum field of view of the UTA 20. Typical obstructions can be things such as buildings, trees, or interference sources that reduce the field of view 47 of the UTA 20 to less than the maximum field of view. Practical considerations can also reduce the field of view 47 to less than the maximum field of view. For example, the number and spacing of the orbital planes 44 and the number and spacing of the plurality of satellites 40 within an orbital plane 44 can be such that multiple orbital planes 44 and multiple satellites 40 can be within the maximum field of view simultaneously such that the entire maximum field of view does not need to be utilized to communicate with the satellite communication system 38. Therefore, the typical field of view 47 of the UTA 20 is a subset of the maximum field of view of the UTA 20. For purposes of explaining the present invention, no further distinction between the maximum field of view and the field of view 47 of the UTA 20 will be made and will be referred to simply as the field of view 47. The field of view 47 of the UTA 20, therefore, represents the volume of space within which the UTA 20 can communicate with any satellite 40 of the satellite communication system 38.

When it is desired to communicate with the satellite communication system 38, the controller 36 will tilt the array antenna 32 about the tilt axis 72 until the field of view 71 of the array antenna 32 is oriented toward a first orbital plane 76 of the plurality of orbital planes 44. Preferably, the controller 36 will tilt the array antenna 32 about the tilt axis 72 so that the scan axis 48 of the array antenna 32 is generally aligned with the first orbital plane 76. Because the controller 36 knows the orbits and positions of the plurality of satellites 40 in each orbital plane 44 of the plurality of orbital planes 44, the controller 36 can predict when a particular satellite 40 within a particular orbital plane 44 is within the field of view 47 of the UTA 20 and capable of being acquired and tracked by the UTA 20. When the array antenna 32 has been tilted so that the first orbital plane 76 is within the field of view 71 of the array antenna 32, the controller 36 will cause the array antenna 32 to electronically scan to a position where a first satellite 74 in the first orbital plane 76 is located so that the array antenna 32 can acquire the first satellite 74. Once the array antenna 32 has acquired the first satellite 74 in the first orbital plane 76, the array antenna 32 electronically tracks the first satellite 74 as it travels through the field of view 71 of the array antenna 32 as the first satellite 74 in the first orbital plane 76 orbits the earth 41. Preferably, the controller 36 tilts the tilt plate 30 about the tilt axis 72 as the array antenna 32 electronically tracks a first satellite 74 in the first orbital plane 76 so that the field of view 71 of the array antenna 32 remains oriented toward the first orbital plane 76 while the array antenna 32 tracks the first satellite 74 in the first orbital plane 76. The tilting of the tilt plate 30 about the tilt axis 72 compensates for the rotation of the earth 41 so that the field of view 71 and the electronic scan axis 48 remain oriented toward the first orbital plane 76 while the earth 41 rotates.

As can be seen in FIGS. 4A-B, when the first satellite 74 in the first orbital plane 76 reaches a predetermined satellite release location 78, the array antenna 32 switches from tracking the first satellite 74 in the first orbital plane 76 to tracking a second satellite 80 in the first orbital plane 76. Because the array antenna 32 has been tilted about the tilt axis 72 so that the field of view 71 of the array antenna 32 is oriented toward the first orbital plane 76, the switching between tracking the first satellite 74 in the first orbital plane 76 to tracking the second satellite 80 in the first orbital plane 76 can be accomplished by electronically scanning (retracing) along the scan axis 48 to a predetermined satellite acquisition location 82 in the field of view 71 of the array antenna 32. This switching is accomplished by an almost instantaneous retrace of the antenna beam. A characteristic of the electronically scanned phased array antennas used in the invention is that they can change their scan angle almost instantaneously. Thus, switching from one satellite to another in the same orbital plane is accomplished without loss of communication. When the array antenna 32 is switching from tracking the first satellite 74 in the first orbital plane 76 to tracking the second satellite 80 in the first orbital plane 76, the array antenna 32 will release the first satellite 74 in the first orbital plane 76 by ceasing to track the first satellite 74 in the first orbital plane 76 as the first satellite 74 in the first orbital plane 76 continues to travel pass the predetermined satellite release location 78 in the field of view 71 of the array antenna 32. The array antenna 32 will then acquire the second satellite 80 in the first orbital plane 76, as was described above, and begin tracking the second satellite 80 in the first orbital plane 76 as the second satellite 80 in the first orbital plane 76 orbits the earth 41 in the first orbital plane 76 and travels through the field of view 71 of the array antenna 32 between the predetermined satellite acquisition location 82 and the predetermined satellite release location 78. The releasing of an individual satellite 40, electronically rescanning along the scan axis 48, and acquiring of a different individual satellite 40 within the same orbital plane is referred to as an intraplane retrace. Because the scanning of the array antenna 32 along the scan axis 48 is performed electronically, the switching is almost instantaneous. The almost instantaneous switching prevents the loss of data being sent between the UTA 20 and the satellite communication system 38 during intraplane retrace.

FIGS. 4A-B show a two-dimensional graphical representation of intraplane retracing as the first orbital plane 76 passes through the field of view 47 of the UTA 20. The field of view 47 is superimposed on the representation of the earth 41 above 400 elevation angle. A ground track 84 projected by the first satellite 74 in the first orbital plane 76 as the first satellite 74 orbits the earth 41 in the first orbital plane 76 is shown. The ground track 84 shows the first satellite 74 in the first orbital plane 76 passing the satellite acquisition location 82, travelling through the field of view 47 of the UTA 20, and passing the satellite release location 78. The electronic tracking of the first satellite 74 in the first orbital plane 76 by the array antenna 32 is represented by the arrow 86. As was discussed above, the array antenna 32 will track the first satellite 74 as it passes through the field of view 47 of the UTA 20 until the first satellite 74 in the first orbital plane 76 passes the satellite release location 78.

When the first satellite 74 in the first orbital plane 76 reaches the satellite release location 78, the array antenna 32 will perform an intraplane retrace which is represented by arrow 87. As was discussed above, the array antenna 32 electronically scans along the first orbital plane 76 to the predetermined satellite acquisition location 82. As can be seen in FIGS. 4A-B, the intraplane retracing is a true North-South electronic scan because the array antenna 32 has been oriented so that the scan axis 48 is in the North-South direction. It can also be seen that the ground track 84 projected by the first satellite 74 in the first orbital plane 76 has a slant to the West due to the rotation of the earth 41. The tracking 86 of the first satellite 74 in the first orbital plane 76 as it passes through the field of view 71 of the array antenna 32 also has a slant to the West due to the array antenna 32 being tilted about the tilt axis 72 so that the field of view 71 of the array antenna 32 remains oriented toward the first orbital plane 76.

The ground track 90 projected by the second satellite 80 in the first orbital plane 76 is shown in FIG. 4A. When the array antenna 32 performs the intraplane retrace 87 and electronically scans to the satellite acquisition location 82, the second satellite 80 in the first orbital plane 76 is within the field of view 71 of the array antenna 32 and is acquired by the array antenna 32. The array antenna 32 then tracks, as represented by arrow 92, the path of the second satellite 80 in the first orbital plane 76 as the second satellite 80 in the first orbital plane 76 travels through the field of view 71 of the array antenna 32. When the second satellite 80 in the first orbital plane 76 reaches the satellite release location 78, the array antenna 32 performs an intraplane retrace, represented by arrow 94 and the array antenna 32 releases the second satellite 80 in the first orbital plane 76 by ceasing to track the second satellite 80 in the first orbital plane 76. The array antenna 32 then electronically scans along the orbital path of the first orbital plane 76 from the satellite release location 78 to the satellite acquisition location 82 wherein a third satellite 96 of the plurality of satellites 40 in the first orbital plane 76 can be acquired, tracked and released. The process of acquiring, tracking and releasing a satellite 40 in an orbital plane 44 and then acquiring, tracking and releasing another satellite 40 within the same orbital plane 44 is repeated until the orbital plane 44 is at a predetermined orbital plane release location 98 at which time an interplane retrace occurs.

When the first orbital plane 76 is at the predetermined orbital plane release location 98, the UTA 20 performs an interplane retrace, indicated by interplane retrace arrow 99, by having the array antenna 32 electronically scan or retrace from the satellite release location 78 to the satellite acquisition location 82 while being simultaneously tilted about the tilt axis 72 from the orbital plane release location 98 to an orbital plane acquisition location 100. The interplane retrace 99 causes the field of view 71 of the array antenna 32 to go from being oriented toward the first orbital plane 76 to being oriented toward a second orbital plane 102 of the plurality of orbital planes 44. The array antenna 32 then acquires a first satellite 104 of the plurality of satellites 40 in the second orbital plane 102. The array antenna 32 then proceeds to track the first satellite 104 in the second orbital plane 102 as the first satellite 104 in the second orbital plane 102 travels through the field of view 71 of the array antenna 32 between the satellite acquisition location 82 and the satellite release location 78. The array antenna 32, then performs an intraplane retrace along the second orbital plane 102 to acquire a second satellite 108 of the plurality of satellites 40 in the second orbital plane 102. The process of acquiring, tracking, and releasing a satellite 40 in the second orbital plane 102 and then retracing and acquiring, tracking and releasing another satellite 40 in the second orbital plane 102 is repeated until the second orbital plane 102 is at the predetermined orbital plane release location 98 at which time an interplane retrace, as was discussed above, is performed so that a first satellite 110 of the plurality of satellites 40 in a third orbital plane 112 of the plurality of orbital planes 44 can be acquired, tracked and released.

The above described process of the array antenna 32 acquiring, tracking, and releasing various satellites 40 in the orbital planes 44 is repeated continuously until there is no longer a desire to communicate between the UTA 20 and the satellite communication system 38. With this process, the UTA 20 can remain in contact with the communication system 38. When an interplane retrace 99 is occurring, there is a temporary loss in communication between the UTA 20 and the satellite communication system 30, because of the time required to accomplish the mechanical tilt movement. That is, because the array antenna 32 is positioned so that the field of view 71 of array antenna 32 is oriented toward the first orbital plane 76 at the orbital plane release location 98, the gimbal 28 must rotate about the tilt axis 72 until the field of view 71 of the array antenna 32 is oriented toward the second orbital plane 102 at the orbital plane acquisition location 100. Dependent upon the location of the predetermined orbital plane release location 98 relative to the predetermined orbital plane acquisition location 100, the degrees of tilt through which the tilt plate 30 must tilt about the tilt axis 72 can vary. Therefore, the amount of time required to perform the interplane retrace will also vary. It is expected that the interplane retrace operation will take a few seconds. Therefore, prior to an interplane retrace occurring, it is preferred that a data transfer protocol that ceases communications during an interplane retrace is established between the satellite communication system 38 and the controller 36. The data transfer protocol establishes a predetermined time at which the controller 36 and the satellite communication system 38 will cease transferring data to and from one another and will buffer the data until the interplane retrace is completed. Once the interplane retrace has been completed, the data transfer protocol will instruct the UTA 20 and satellite communication system 38 to transfer the information stored during the interplane retrace between the satellite communication system 38 and the UTA 20. In this manner, no data is lost during the interplane retrace operation.

FIG. 4B shows the intraplane retracing and interplane retracing of the array antenna 32 when the satellites 40 in the orbital planes 44 descend to the South. The intraplane retracing and interplane retracing are similar to that described above and shown in FIG. 4A.

Because ascending (North heading) satellites must necessarily descend (head South) on the other side of the earth 41, the satellite constellation 42 must have at least one “seam” 114 where an ascending and descending orbital plane are adjacent to each other. When an interplane retrace crosses the constellation seam 114, the array antenna 32 tilts about the tilt axis 72 so that the field of view 71 of the array antenna 32 is oriented toward the orbital plane acquisition location 100, as was described above, but the array antenna 32 does not perform an intraplane retrace because the satellite release location 78 at which the array antenna 32 is oriented becomes the satellite acquisition location 82 when the interplane retrace crosses the constellation seam 114. The intraplane and interplane retraces then occur, as was described above, and as shown in FIG. 4B until an interplane retraces again crosses the constellation seam 114. The intraplane and interplane retraces then occur as shown in FIG. 4A.

The number of orbital planes 44 in the satellite constellation 42 and the spacing of those orbital planes 44 effect the location of the orbital plane acquisition location 100 and the orbital plane release location 98. That is, the UTA 20 cannot perform an interplane retrace until there is another orbital plane 44 within the field of view 47 of the UTA 20. The number of satellites 40 within a given orbital plane 44 effects the locations of the satellite acquisition location 82 and the satellite release location 78. That is, the array antenna 32 can not perform an intraplane retrace until another satellite 40 is in the same orbital plane 44 and within the field of view 71 of the array antenna 32. Additionally, the spacing between the orbital planes 44 and between the satellites 40 in each orbital plane 44 is preferably equal but the invention will also work with non-uniform spacing. Therefore, it is not desirable to position the orbital plane acquisition location 100, the orbital plane release location 98, the satellite acquisition location 82 and the satellite release location 78 at the edges of the field of view 47 of the UTA 20 because no margin for error in the operation or orientation of the array antenna 32 nor for non uniform spacing of the orbital planes 44 or the satellites 40 would be provided. Therefore, it is preferred that the orbital plane acquisition location 100, the orbital plane release location 98, the satellite acquisition location 82, and the satellite release location 78 be positioned well within the field of view 47 of the UTA 20 so that the UTA 20 can account for potential variations in the satellite communication system 38.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. A fixed terrestrial user terminal antenna for satellite communication systems in which satellites orbit earth in a constellation comprised of a plurality of spaced orbital planes with each orbital plane of the plurality of orbital planes having a plurality of satellites, the user terminal antenna comprising:
a base, the base providing support for the user terminal antenna;
a tilt plate, the tilt plate being connected to the base and being capable of being tilted relative to the base; and
a 1-dimensional electronically scanned phased array antenna that scans along a single scan axis, the array antenna being attached to the tilt plate so that the array antenna tilts with the tilting of the tilt plate, and the array antenna tracking individual satellites of the plurality of satellites in an orbital plane of the plurality of orbital planes as the individual satellites travel through a field of view of the array antenna so that the array antenna can transmit data to and receive data from the individual satellites.

2. The user terminal antenna of claim 1, wherein:
the scan axis of the array antenna is oriented to be generally aligned with the orbits of the plurality of satellites in the plurality of orbital planes so that the array antenna can track a first satellite of the plurality of satellites in a first orbital plane of the plurality of orbital planes as the first satellite in the first orbital plane travels through the field of view of the array antenna.

3. The user terminal antenna of claim 2, wherein:
the array antenna switches from tracking the first satellite in the first orbital plane to tracking a second satellite of the plurality of satellites in the first orbital plane when the first satellite in the first orbital plane reaches a predetermined satellite release location in the field of view of the array antenna.

4. The user terminal antenna of claim 3, wherein:
the array antenna switches from tracking the first satellite in the first orbital plane to tracking the second satellite in the first orbital plane by retracing the first orbital plane to a predetermined satellite acquisition location.

5. The user terminal antenna of claim 2, wherein:
the tilt plate tilts about a single tilt axis that is generally aligned with the scan axis.

6. The user terminal antenna of claim 2, wherein:
the tilt plate tilts about a single tilt axis; and
the tilt plate tilts about the tilt axis as the array antenna tracks the first satellite in the first orbital plane, the tilting of the tilt plate compensating for rotation of the earth so that the field of view of the array antenna remains oriented toward the first orbital plane and the array antenna is capable of transmitting data to and receiving data from the first satellite in the first orbital plane.

7. The user terminal antenna of claim 2, wherein:
the tilt plate tilts about a single tilt axis; and
the tilt plate tilts about the tilt axis to a predetermined orbital plane acquisition location when the array antenna switches from tracking individual satellites of the plurality of satellites in the first orbital plane to tracking individual satellites of the plurality of satellites in a second orbital plane of the plurality of orbital planes, the tilting of the tilt plate to the predetermined orbital plane acquisition location causing the field of view of the array antenna to be oriented toward the second orbital plane of the plurality of orbital planes so that a first individual satellite of the plurality of satellites in the second orbital plane of the plurality of orbital planes can be tracked and data transmitted to and received from the first individual satellite in the second orbital plane.

8. The user terminal antenna of claim 2, wherein:
the array antenna is a dual feed array antenna so that the array antenna can simultaneously transmit and receive data.

9. The user terminal antenna of claim 2, wherein:
the array antenna has separate transmission and reception apertures, and the transmission aperture transmitting data to and the reception aperture receiving data from the individual satellites being tracked by the antenna array.

10. The user terminal antenna of claim 2, wherein:
the orbits of the plurality of satellites in the plurality of orbital planes are polar orbits;
the array antenna is oriented so that the scan axis generally extends North and South; and
the tilt plate tilts about a single tilt axis that is generally aligned with the scan axis.

11. The user terminal antenna of claim 2, wherein:
the plurality of spaced orbital planes are equally spaced apart.

12. The user terminal antenna of claim 2, wherein:
the array antenna has an aperture with a width and a length, the aperture length extending along the scan axis with the aperture width being generally perpendicular to the aperture length, and the aperture length being greater than the aperture width.

13. The user terminal antenna of claim 12, wherein:
the aperture width is dimensioned so that a width of an antenna beam produced by the array antenna compensates for curvature of the orbits of the plurality of satellites in the plurality of orbital planes.

14. A method of using a terrestrial user terminal antenna having a one dimensional electronically scanned phased array antenna with a single scan axis that is attached to a tilt plate that tilts about a single tilt axis to communicate with a satellite communication system in which satellites orbit earth in a constellation comprised of a plurality of spaced orbital planes with each orbital plane of the plurality of orbital planes having a plurality of satellites, the method comprising the steps of:
orienting the user terminal antenna so that the scan axis of the array antenna is generally aligned with orbits of the plurality of satellites in the plurality of orbital planes;
acquiring a first satellite of the plurality of satellites in a first orbital plane of the plurality of orbital planes that is in a field of view of the array antenna;
tracking the first satellite in the first orbital plane while the first satellite in the first orbital plane travels through the field of view of the array antenna as the first satellite in the first orbital plane orbits the earth; and
transmitting data to and receiving data from the first satellite in the first orbital plane while the array antenna is tracking the first satellite in the first orbital plane.

15. The method of claim 14, further comprising the step of:
tilting the tilt plate to a predetermined orbital plane acquisition location so that the field of view of the array antenna is oriented toward the first orbital plane of the plurality of orbital planes prior to performing the step of acquiring a first satellite.

16. The method of claim 15, wherein the step of tracking the first satellite includes the step of:
tilting the tilt plate about the tilt axis as the array antenna tracks the first satellite in the first orbital plane so that the field of view of the array antenna remains oriented toward the first orbital plane while the array antenna tracks the first satellite in the first orbital plane.

17. The method of claim 16, wherein the step of tracking the first satellite includes the steps of:
tracking the first satellite in the first orbital plane until the first satellite in the first orbital plane is at a predetermined satellite release location;
releasing the first satellite in the first orbital plane by ceasing to track the first satellite in the first orbital plane as the first satellite in the first orbital plane continues to travel past the predetermined satellite release location;
acquiring a second satellite of the plurality of satellites in the first orbital plane by scanning with the array antenna to a predetermined satellite acquisition location;
tracking the second satellite in the first orbital plane as the second satellite in the first orbital plane orbits the earth in the first orbital plane and travels through the field of view of the array antenna between the predetermined satellite acquisition location and the predetermined satellite release location; and
the step of transmitting data to and receiving data from the first satellite further comprises transmitting data to and receiving data from any satellite of the plurality of satellites in any orbital plane of the plurality of orbital planes that is being tracked by the array antenna.

18. The method of claim 17, further comprising the step of:
releasing the second satellite in the first orbital plane when the second satellite in the first orbital plane is at the predetermined satellite release location; and
wherein the steps of acquiring, tracking, and releasing a first satellite in the first orbital plane and then acquiring, tracking, and releasing a second satellite in the first orbital plane repeats for each satellite of the plurality of satellites in the first orbital plane until the first orbital plane is at a predetermined orbital plane release location.

19. The method of claim 18, further comprising the steps of:
releasing the first orbital plane by ceasing to track any satellite of the plurality of satellites in the first orbital plane when the first orbital plane is at the predetermined orbital plane release location;
tilting the tilt plate about the tilt axis to the predetermined orbital plane acquisition location when the first orbital plane is at the predetermined orbital plane release location so that the field of view of the array antenna is oriented toward a second orbital plane of the plurality of orbital planes; and
wherein the steps of acquiring, tracking, and releasing each satellite of the plurality of satellites in the first orbital plane are performed for each satellite of the plurality of satellites in the second orbital plane while the second orbital plane is between the predetermined orbital plane acquisition location and the predetermined orbital plane release location.

20. The method of claim 19, wherein the step of transmitting and receiving data includes the steps of:
negotiating a data transfer protocol prior to switching from tracking an individual satellite of the plurality of satellites in the first orbital plane to tracking an individual satellite of the plurality of satellites in the second orbital plane so that no data is lost due to the switching.
